(19) United States
(12) Patent Application Publication
(10) Pub. No.: US 2025/0184958 A1
(43) Pub. Date: Jun. 5, 2025

(54) METHOD AND APPARATUS FOR INTELLIGENT POSITIONING OF COMMUNICATION SYSTEM

(71) Applicant: ELECTRONICS AND TELECOMMUNICATIONS RESEARCH INSTITUTE, Daejeon (KR)

(72) Inventors: Seungjae BAHNG, Daejeon (KR); Yong Jin KWON, Daejeon (KR); Anseok LEE, Daejeon (KR); Heesoo LEE, Daejeon (KR); Yunjoo KIM, Daejeon (KR); Hyun Seo PARK, Daejeon (KR); Jungbo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 18/962,948

(22) Filed: Nov. 27, 2024

(30) Foreign Application Priority Data
Nov. 30, 2023 (KR) 10-2023-0171884
Nov. 19, 2024 (KR) 10-2024-0165140

(51) Int. Cl. H04W 64/00; H04W 8/24

(52) U.S. Cl. CPC H04W 64/006; H04W 8/24

(57) ABSTRACT

A method of a first communication node may comprise: determining an intelligent positioning model including at least one positioning functionality for positioning of a second communication node based on a capability information report received from the second communication node; training the intelligent positioning model using a data set received from the second communication node; transmitting the trained intelligent positioning model to the second communication node; and receiving, from the second communication node, an inference result through the intelligent positioning model, and determining a position of the second communication node.

### CROSS-REFERENCE TO RELATED APPLICATIONS

This application claims priority to Korean Patent Applications No. 10-2023-0171884, filed on Nov. 30, 2023, and No. 10-2024-0165140, filed on Nov. 19, 2024, with the Korean Intellectual Property Office (KIPO), the entire contents of which are hereby incorporated by reference.

### BACKGROUND

### 1. Technical Field

The present disclosure relates to an intelligent technique for a communication system, and more particularly, to an intelligent technique for estimating a position of a communication node using an intelligent positioning model.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, there has been active discussion on leveraging intelligent technologies using artificial intelligence (AI) or machine learning (ML) in modern communication systems. The 3GPP is conducting research on intelligent technologies for NR air interfaces. The intelligent technologies in communication systems may be applied in areas such as enhancing Channel State Information (CSI) feedback, beam management, and positioning accuracy.

Among these, enhancement of positioning accuracy may involve using an intelligent model to estimate and determine a precise position of a specific communication node (e.g. terminal) in a communication system. Positioning of a communication node using the intelligent model, in other words, position estimation, may be classified according to an entity responsible for estimating the position of the communication node, such as UE-based and network-based types. Additionally, positioning of a communication node using the intelligent model may be classified according to data used for position estimation, such as Cell-ID-based, angle-based, range-based, and fingerprint-based types.

Recently, there has been an increasing demand for enhanced positioning accuracy of communication nodes indoors. As a result, discussions are ongoing regarding methods to improve the positioning accuracy of communication nodes by leveraging intelligent technologies.

### SUMMARY

The present disclosure for resolving the above-described problems is directed to providing a method and apparatus for intelligent positioning of a communication system, which enhance positioning accuracy for a communication node using an intelligent model.

A method of a first communication node for intelligent positioning, according to an exemplary embodiment of the present disclosure for achieving the above-described objective, may comprise: determining an intelligent positioning model including at least one positioning functionality for positioning of a second communication node based on a capability information report received from the second communication node; training the intelligent positioning model using a data set received from the second communication node; transmitting the trained intelligent positioning model to the second communication node; and receiving, from the second communication node, an inference result through the intelligent positioning model, and determining a position of the second communication node.

The determining of the intelligent positioning model may comprise: transmitting a capability information request to the second communication node; in response to the capability information request, receiving, from the second communication node, a capability information report including a plurality of positioning functionalities supportable by the second communication node; transmitting, to the second communication node, Radio Resource Control (RRC) configuration information for configuring at least one positioning functionality among the plurality of positioning functionalities, based on the capability information report; receiving, from the second communication node, an RRC configuration completion report for the RRC configuration information; and determining the intelligent positioning model including the configured at least one positioning functionality.

The determining of the intelligent positioning model may comprise: dividing a cell coverage of the first communication node into a plurality of zones; transmitting, to the second communication node, division information for the plurality of zones; receiving, from the second communication node, additional information including localization result information on a result of localization performed based on the division information; and determining the intelligent positioning model based on at least one of the at least one positioning functionality and the additional information.

The division information may include a cell identifier (ID) for the first communication node and a zone ID for each of the plurality of zones, the localization result information may include a plurality of probability values each of which is a probability that the second communication node is located in each of the plurality of zones, and the additional information may include zone ID(s) of at least one zone corresponding to at least one probability value including a maximum probability value among the plurality of probability values of the localization result information among the plurality of zones.

The training of the intelligent positioning model may comprise: transmitting data collection instruction information to the second communication node; and receiving, from the second communication node, the data set including at least one data unit collected based on the data collection instruction information.

The determining of the position of the second communication node may comprise: transmitting inference instruction information to the second communication node; receiving, from the second communication node, the inference result including an estimated position of the second communication node obtained through the intelligent positioning model; and determining the position of the second communication node based on the estimated position.

The method may further comprise: dividing a cell coverage of the first communication node into a plurality of zones and transmitting division information for the plurality of zones to the second communication node; receiving, from the second communication node, localization result information on a result of localization performed based on the division information at a preset periodicity; and determining whether to switch the determined intelligent positioning model based on the localization result information.

The localization result information may include a plurality of probability values each of which is a probability that the second communication node is located in each of the plurality of zones, and the determining of whether to switch the intelligent positioning model may comprise: comparing a probability value of a zone corresponding to the position of the second communication node among the plurality of zones with a preset reference value, based on the plurality of probability values; and in response to the probability value being less than the preset reference value, switching the intelligent positioning model.

A method of a second communication node for intelligent positioning, according to an exemplary embodiment of the present disclosure for achieving the above-described objective, may comprise: in response to a capability information request received from a first communication node, transmitting, to the first communication node, a capability information report including a plurality of positioning functionalities supportable by the second communication node; configuring at least one positioning functionality among the plurality of positioning functionalities based on Radio Resource Control (RRC) configuration information received from the first communication node; in response to data collection instruction information received from the first communication node, collecting one or more data units corresponding to the at least one positioning functionality, and transmitting a data set including the collected data units to the first communication node; receiving, from the first communication node, an intelligent positioning model trained by the data set; and in response to inference instruction information received from the first communication node, estimating a position of the second communication node using the intelligent positioning model, and transmitting an inference result including the estimated position to the first communication node.

The method may further comprise: receiving, from the first communication node, division information for a plurality of zones into which a cell coverage of the first communication node is divided; determining localization result information including a plurality of probability values each of which is a probability that the second communication node is located in each of the plurality of zones by performing localization of the second communication node based on the division information; and transmitting, to the first communication node, additional information including the localization result information.

The additional information may include zone identifier(s) (ID(s)) for at least one zone corresponding to at least one probability value including a maximum probability value among the plurality of probability values of the localization result information among the plurality of zones.

The data collection instruction information may include a threshold value, and the transmitting of the data set may comprise: comparing a probability value for a zone in which the second communication node is located among the plurality of probability values with the threshold value; and in response to the probability value being equal to or greater than the threshold value, transmitting the data set to the first communication node, wherein the data set may not be transmitted when the probability value is less than the threshold value.

A first communication node for intelligent positioning, according to an exemplary embodiment of the present disclosure for achieving the above-described objective, may comprise at least one processor, wherein the at least one processor causes the first communication node to perform: determining an intelligent positioning model including at least one positioning functionality for positioning of a second communication node based on a capability information report received from the second communication node; training the intelligent positioning model using a data set received from the second communication node; transmitting the trained intelligent positioning model to the second communication node; and receiving, from the second communication node, an inference result through the intelligent positioning model, and determining a position of the second communication node.

In the determining of the intelligent positioning model, the at least one processor causes the first communication node to perform: transmitting a capability information request to the second communication node; in response to the capability information request, receiving, from the second communication node, a capability information report including a plurality of positioning functionalities supportable by the second communication node; transmitting, to the second communication node, Radio Resource Control (RRC) configuration information for configuring at least one positioning functionality among the plurality of positioning functionalities, based on the capability information report; receiving, from the second communication node, an RRC configuration completion report for the RRC configuration information; and determining the intelligent positioning model including the configured at least one positioning functionality.

In the determining of the intelligent positioning model, the at least one processor may cause the first communication node to perform: dividing a cell coverage of the first communication node into a plurality of zones; transmitting, to the second communication node, division information for the plurality of zones; receiving, from the second communication node, additional information including localization result information on a result of localization performed based on the division information; and determining the intelligent positioning model based on at least one of the at least one positioning functionality and the additional information.

The division information may include a cell identifier (ID) for the first communication node and a zone ID for each of the plurality of zones, the localization result information may include a plurality of probability values each of which is a probability that the second communication node is located in each of the plurality of zones, and the additional information may include zone ID(s) of at least one zone corresponding to at least one probability value including a maximum probability value among the plurality of probability values of the localization result information among the plurality of zones.

In the training of the intelligent positioning model, the at least one processor may cause the first communication node to perform: transmitting data collection instruction information to the second communication node; and receiving, from the second communication node, the data set including at least one data unit collected based on the data collection instruction information.

In the determining of the position of the second communication node, the at least one processor may cause the first communication node to perform: transmitting inference instruction information to the second communication node; receiving, from the second communication node, the inference result including an estimated position of the second communication node obtained through the intelligent positioning model; and determining the position of the second communication node based on the estimated position.

The at least one processor may further cause the first communication node to perform: dividing a cell coverage of the first communication node into a plurality of zones and transmitting division information for the plurality of zones to the second communication node; receiving, from the second communication node, localization result information on a result of localization performed based on the division information at a preset periodicity; and determining whether to switch the determined intelligent positioning model based on the localization result information.

The localization result information may include a plurality of probability values each of which is a probability that the second communication node is located in each of the plurality of zones, and in the determining of whether to switch the intelligent positioning model, the at least one processor may cause the first communication node to perform: comparing a probability value of a zone corresponding to the position of the second communication node among the plurality of zones with a preset reference value, based on the plurality of probability values; and in response to the probability value being less than the preset reference value, switching the intelligent positioning model.

According to the present disclosure, the first communication node can enhance the training performance of the intelligent positioning model and improve the positioning accuracy of the second communication node using the intelligent positioning model by determining and training the model based on the positioning functionality of the second communication node.

Additionally, the present disclosure enables the first communication node to enhance operational reliability of the intelligent positioning model by determining a need for changing the intelligent positioning model through performance monitoring of the intelligent positioning model based on the localization results for the respective multiple zones within the cell coverage received from the second communication node.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram classifying intelligent positioning in a communication system.

FIG. 4 is a flowchart illustrating exemplary embodiments of methods for intelligent positioning in a communication system.

FIGS. 5 and 6 are conceptual diagrams illustrating exemplary embodiments of dividing a cell coverage of a base station into multiple zones.

FIG. 7 is a conceptual diagram illustrating an exemplary embodiment of terminal localization.

FIG. 8 is a sequence chart illustrating exemplary embodiments of a method for determining an intelligent positioning model.

FIG. 9 is a conceptual diagram illustrating an exemplary embodiment of positioning functionalities included in a capability information report transmitted by a terminal.

FIG. 10 is a conceptual diagram illustrating an exemplary embodiment of localization results included in additional information transmitted by a terminal.

FIG. 11 and FIG. 12 are conceptual diagrams illustrating exemplary embodiments of intelligent positioning categorized by case.

FIG. 13 is a sequence chart illustrating exemplary embodiments of a method for training an intelligent positioning model.

FIG. 14 is a conceptual diagram illustrating an exemplary embodiment of data collection instruction information transmitted by a base station.

FIG. 15 is a sequence chart illustrating an exemplary embodiment of a method for determining a terminal position using an intelligent positioning model.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

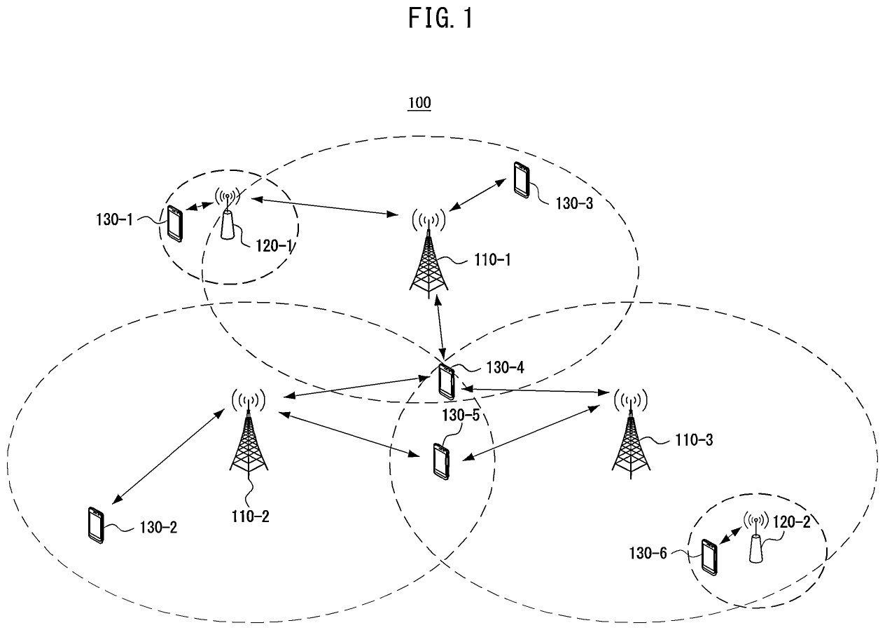

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

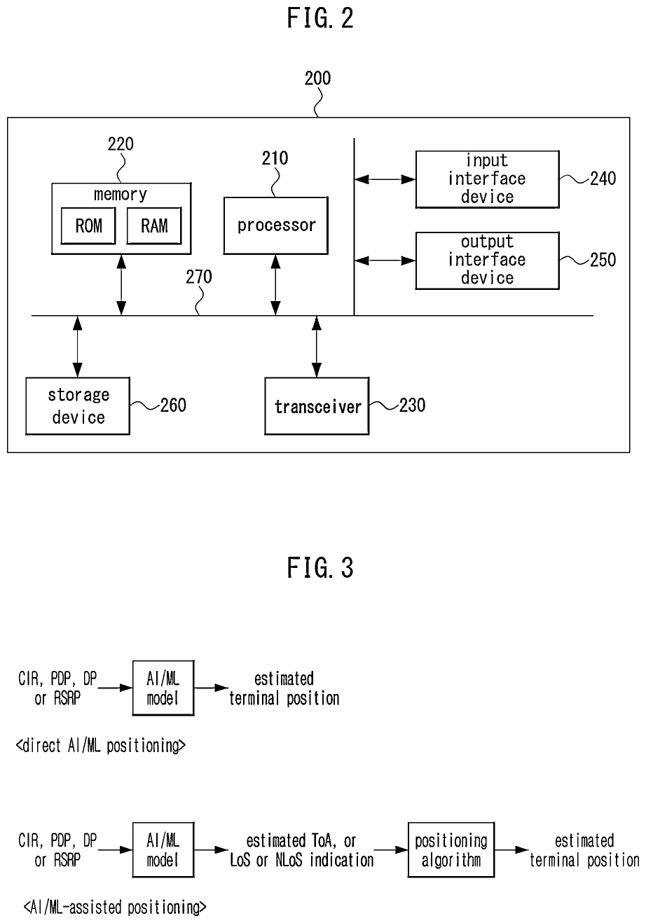

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

The aforementioned communication node 200 may include one or more AI/ML models, such as intelligent models, capable of performing intelligent positioning in the communication system 100. The intelligent model may be stored in the memory 220 or storage device 260 of the communication node 200.

The intelligent model of the communication node 200 may be classified into a one-sided model or a two-sided model depending on a type of intelligent operations it performs. For example, if intelligent positioning is performed using an intelligent model located in a single communication node, the model may be referred to as a one-sided model. On the other hand, if intelligent positioning is performed using intelligent models located in two or more communication nodes in conjunction, the model may be referred to as a two-sided model.

For intelligent positioning of the communication node 200 using an intelligent model, training of the intelligent model may be required. Training of the intelligent model may be conducted based on a predetermined data set, such as a training dataset, corresponding to a configured intelligent functionality.

The performance of intelligent positioning using the intelligent model may vary depending on the extent of the model's training. Therefore, in order to generate, maintain, or update the intelligent functionality or model according to changes in the training dataset, Life Cycle Management (LCM) for the intelligent mode may be performed. The life cycle management for the intelligent model may include stages such as data collection, model training, model inference, model deployment, model activation, model deactivation, model selection, model switching, model fallback, and model monitoring.

FIG. 3 is a conceptual diagram classifying intelligent positioning in a communication system.

Referring to FIG. 3, intelligent positioning using an intelligent model (e.g. AI/ML model) in a communication system may be categorized into a direct AI/ML positioning scheme and an AI/ML-assisted positioning scheme, depending on inference results output from the model, such as estimation results.

In the direct positioning scheme, the intelligent model may output an inference result that directly indicates an estimated position of a communication node (e.g. terminal). For instance, in the direct positioning scheme, the intelligent model may obtain (e.g. receive) at least one of a Channel Impulse Response (CIR) signal, Power Delay Profile (PDP) signal, Delay Profile (DP) signal, or Reference Signal Received Power (RSRP) signal as input and output the estimated position of the communication node through an inference operation.

In the AI/ML-assisted positioning scheme, the intelligent model may output an inference result, including one or more pieces of information necessary for estimating a position of the communication node, to a unit performing a traditional positioning algorithm. For example, in the AI/ML-assisted positioning scheme, the intelligent model may receive at least one of a CIR signal, PDP signal, DP signal, or RSRP signal and output, through an inference operation, at least one of an estimated Time of Arrival (ToA), Line of Sight (LoS) indication, or Non-Line of Sight (NLoS) indication to a positioning algorithm unit. Then, the positioning algorithm unit may then output an estimated position of the communication node based on the estimated ToA, LoS indication, or NLoS indication output from the intelligent model.

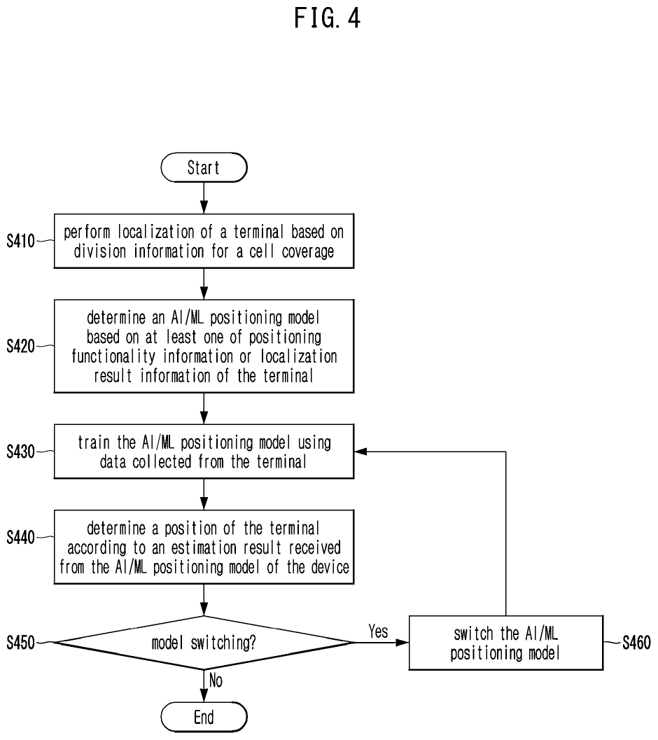

FIG. 4 is a flowchart illustrating exemplary embodiments of methods for intelligent positioning in a communication system.

Hereinafter, a process in which an intelligent model of a second communication node (e.g. terminal) performs positioning under control of a first communication node (e.g. base station) among multiple communication nodes in a communication system will be described as an example.

Referring to FIG. 4, the first communication node may divide a cell coverage, an area where communication services are provided, into multiple zones, for example. The second communication node may receive information on the division (i.e. division information) for the cell coverage, which is transmitted by the first communication node. The second communication node may perform localization of the second communication node based on the received division information (S410).

The division information for the cell coverage, which is transmitted from the first communication node to the second communication node, may include a cell identifier (i.e. Cell_ID) assigned to the first communication node and zone identifiers (i.e. Zone IDs) respectively assigned to the multiple divided zones within the cell coverage of the first communication node.

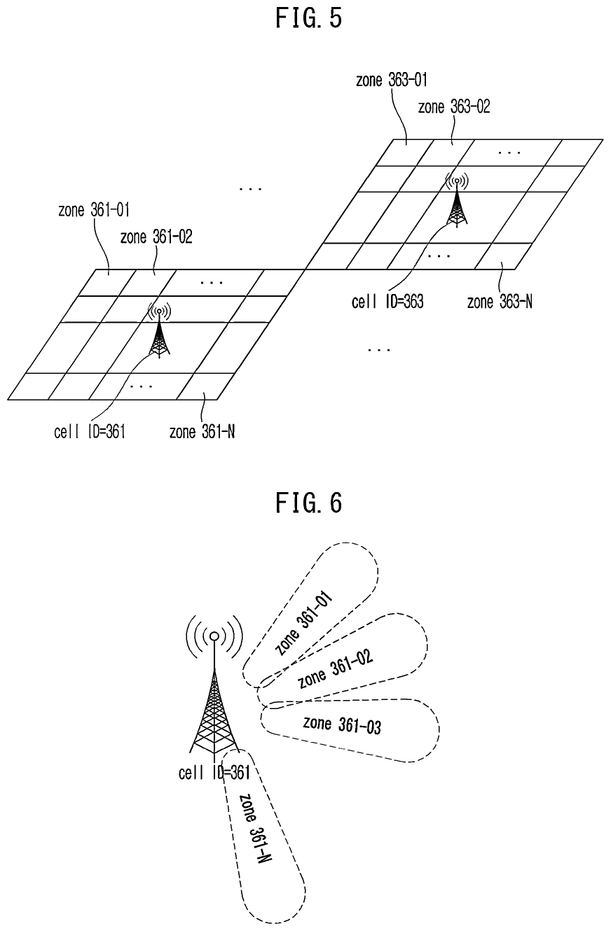

FIGS. 5 and 6 are conceptual diagrams illustrating exemplary embodiments of dividing a cell coverage of a base station into multiple zones.

Referring to FIG. 5, a communication system may include multiple base stations, such as a first communication node 1-1 and a first communication node 1-2. Each of the first communication nodes 1-1 and 1-2 may has a predetermined cell coverage that provides communication services. Each of the first communication nodes 1-1 and 1-2 may be assigned a cell ID. For example, the first communication node 1-1 may be assigned a cell ID 361, and the first communication node 1-2 may be assigned a cell ID 363.

Each of the first communication nodes 1-1 and 1-2 may divide its cell coverage into multiple zones each having a fixed size. Each of the first communication nodes 1-1 and 1-2 may assign a zone ID to each of the divided zones.

For example, the first communication node 1-1 may divide its cell coverage into N (where N is a natural number) zones of a fixed size. The first communication node 1-1 may assign a zone ID (e.g. zone 361-01, zone 361-02, . . . , or zone 361-N), which includes its cell ID (i.e. 361), to each of the N divided zones. The first communication node 1-1 may transmit division information, including its cell ID and multiple zone IDs, to a terminal located within its cell coverage.

Similarly, the first communication node 1-2 may divide its cell coverage into N zones of a fixed size. The first communication node 1-2 may assign a zone ID (e.g. zone 363-01, zone 363-02, . . . , or zone 363-N), which includes its cell ID (i.e. 363), to each of the N divided zones. The first communication node 1-2 may transmit division information, including its cell ID and multiple zone IDs, to a terminal located within its cell coverage.

Referring to FIG. 6, a base station (e.g. the first communication node 1-1 or 1-2) of the communication system may divide its cell coverage into multiple zones based on beams it operates. The base station (i.e. first communication node) may assign a zone ID, including its cell ID, to each of the divided zones.

For example, the first communication node (i.e. the first communication 1-1 in FIG. 5) may be assigned the cell ID 361. As described above, the first communication node may divide its cell coverage into N zones based on each of the multiple beams it operates, assigning a zone ID (e.g. zone 361-01, zone 361-02, . . . , or zone 361-N) to each of the N zones. The first communication node may transmit division information, including its cell ID and multiple zone IDs, to a terminal located within its cell coverage.

Referring again to FIG. 4, the first communication node may include the division information for its cell coverage in a downlink signal (e.g. at least one of a Synchronization Signal Block (SSB) or a Positioning Reference Signal (PRS)) and transmit it to the second communication node. The first communication node may transmit the downlink signal including the division information either during an initial access process of the second communication node or while providing communication services to the second communication node.

The second communication node may perform localization of the second communication node using an intelligent model based on the division information included in the received downlink signal. The localization of the second communication node may involve estimating at least one zone in which the second communication node is expected to be located among the multiple divided zones of the first communication node.

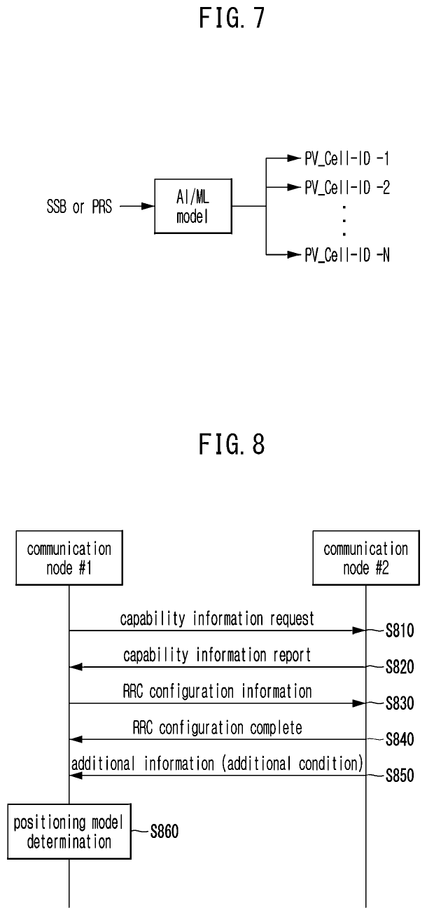

FIG. 7 is a conceptual diagram illustrating an exemplary embodiment of terminal localization.

Referring to FIG. 7, the intelligent model of the second communication node may receive the downlink signal (e.g. SSB or PRS) that includes the division information transmitted from the first communication node. Based on the division information of the downlink signal, the intelligent model may output multiple probability values (e.g. PV_Cell-ID_1, PV_Cell-ID_2, . . . , and PV_Cell-ID_N) each of which indicates a likelihood of the second communication node being located in each of the multiple zones of the first communication node.

Each of the probability values (e.g. PV_Cell-ID_1, PV_Cell-ID_2, . . . , and PV_Cell-ID_N) may be expressed in a percentage (%) form, and a sum of the probability values (e.g. PV_Cell-ID_1, PV_Cell-ID_2, . . . and PV_Cell-ID_N) may equal 100%.

The intelligent model of the second communication node may output the multiple probability values (e.g. PV_Cell-ID_1, PV_Cell-ID_2, . . . , and PV_Cell-ID_N) sorted in the order of the zone IDs assigned to the multiple zones of the first communication node. Alternatively, according to an exemplary embodiment, the intelligent model may output the multiple probability values (e.g. PV_Cell-ID_1, PV_Cell-ID_2, . . . , and PV_Cell-ID_N) sorted in ascending or descending order.

The second communication node may output the multiple probability values (e.g. PV_Cell-ID_1, PV_Cell-ID_2, . . . , and PV_Cell-ID_N) output by the intelligent model as localization result information. Furthermore, according to an exemplary embodiment, the second communication node may output at least one probability value including the maximum probability value among the multiple probability values (e.g. PV_Cell-ID_1, PV_Cell-ID_2, . . . , and PV_Cell-ID_N) as localization result information.

Referring again to FIG. 4, the first communication node may receive information, such as at least one of information on positioning functionalities (i.e. positioning functionality information) of the second communication node or localization result information of the second communication node, from the second communication node. Based on the received positioning functionality information or localization result information of the second communication node, the first communication node may determine an intelligent positioning model, such as an AI/ML positioning model, for positioning of the second communication node (S420).

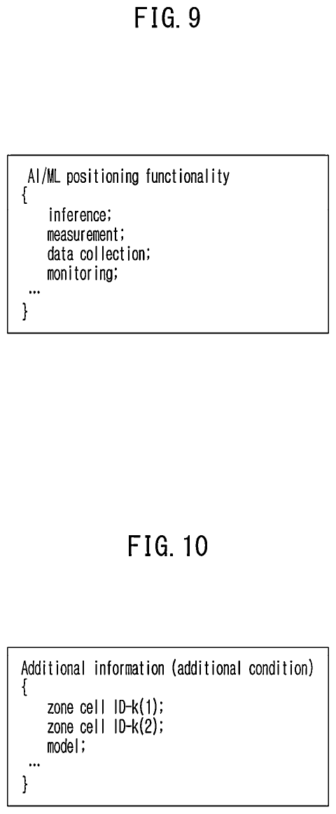

FIG. 8 is a sequence chart illustrating exemplary embodiments of a method for determining an intelligent positioning model, FIG. 9 is a conceptual diagram illustrating an exemplary embodiment of positioning functionalities included in a capability information report transmitted by a terminal, and FIG. 10 is a conceptual diagram illustrating an exemplary embodiment of localization results included in additional information transmitted by a terminal.

Referring to FIG. 8, the first communication node may transmit a capability information request to the second communication node (S810).

Capability information may provide details on the intelligent functionalities that the second communication node can perform using intelligent model(s). In the present disclosure, since the intelligent model is used to infer a position of the second communication node, the first communication node may request capability information regarding the positioning functionality of the second communication node.

The second communication node may transmit a capability information report to the first communication node in response to the capability information request (S820). As described above, since the capability information request from the first communication node relates to positioning functionality, the second communication node may transmit information on one or more positioning functionalities among the multiple intelligent functionalities it can perform using intelligent model(s) through the capability information report. Referring to FIG. 9, the capability information report transmitted by the second communication node may include at least one positioning functionality, such as inference, measurement, data collection, or monitoring.

The first communication node may receive the capability information report transmitted from the second communication node and, based on the capability information report, transmit configuration information to configure at least one positioning functionality, such as RRC configuration information, to the second communication node (S830).

The second communication node may receive the RRC configuration information from the first communication node and configure at least one positioning functionality based on the RRC configuration information. The second communication node may then transmit an RRC configuration completion report to the first communication node based on a configuration result (S840). Thus, the first communication node and the second communication node may each share the configured at least one positioning functionality.

After completing the RRC configuration between the first and second communication nodes, the second communication node may transmit additional information (i.e. addition condition) to the first communication node (S850). The additional information may include information not included in the capability information report of the second communication node. As shown in FIG. 10, the additional information may include at least one of one or more zone IDs based on the localization result information of the second communication node or information on intelligent model(s) of the second communication node.

As described above, the second communication node may output multiple probability values for the respective multiple zones within the cell coverage of the first communication node as the localization result information through localization. The second communication node may select at least one probability value including the maximum probability value among the multiple probability values of the localization result information, and obtain zone ID(s) for at least one zone corresponding to the at least one probability value among the multiple zones. The second communication node may transmit the obtained at least one zone ID to the first communication node by including it in the additional information.

Meanwhile, in the present exemplary embodiment, the second communication node transmits additional information to the first communication node after completing the RRC configuration between the first and second communication nodes. However, the present disclosure is not limited thereto. For example, the second communication node may transmit the capability information report to the first communication node by including the additional information in the capability information report.

Additionally, according to an exemplary embodiment, the first communication node may transmit RRC reconfiguration information to the second communication node based on the additional information received from the second communication node. The second communication node may reconfigure the configured at least one positioning functionality based on the received RRC reconfiguration information and transmit a completion report, such as an RRC reconfiguration complete message regarding a reconfiguration result, to the first communication node.

The first communication node may determine an intelligent positioning model (e.g. AI/ML positioning model) for performing positioning of the second communication node based on at least one of the capability information report or additional information received from the second communication node (S860).

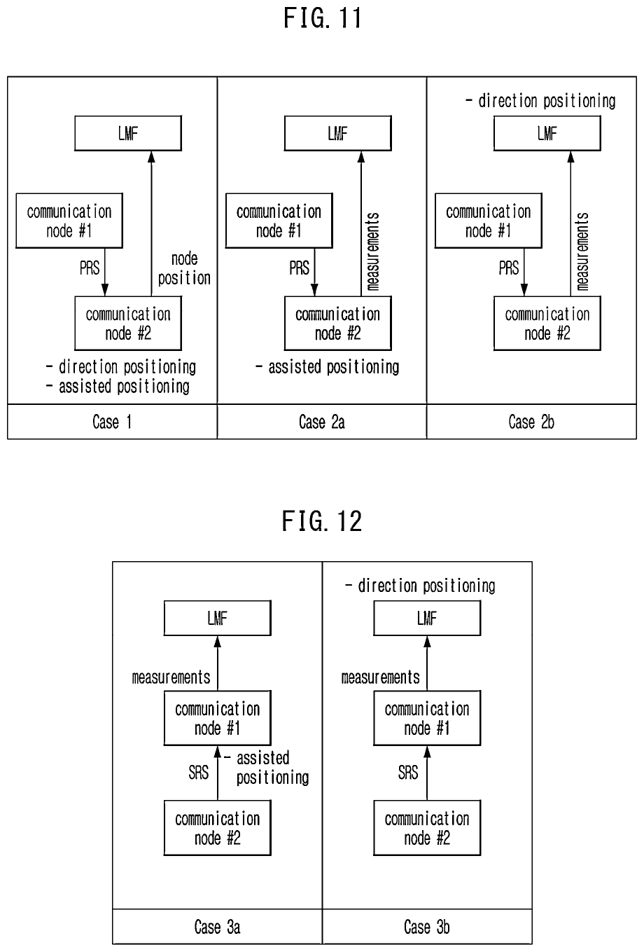

FIG. 11 and FIG. 12 are conceptual diagrams illustrating exemplary embodiments of intelligent positioning categorized by case.

Referring to FIG. 11 and FIG. 12, intelligent positioning may be classified into five positioning cases according to the 3GPP standards. Each of Case 1, Case 2a, and Case 2b shown in FIG. 11 may be a case in which intelligent positioning is performed based on positioning reference signals (PRSs) among downlink signals transmitted from the first communication node (e.g. base station) to the second communication node (e.g. terminal). Each of Case 3a and Case 3b shown in FIG. 12 may be a case in which intelligent positioning is performed based on sounding reference signals (SRSs) among uplink signals transmitted from the second communication node to the first communication node.

Furthermore, Case 1 may be an intelligent positioning type based on the second communication node (i.e. terminal), while Case 2a, Case 2b, Case 3a, and Case 3b may be intelligent positioning types based on a Location Management Function (LMF). Here, the LMF may be a function included in the core network of the communication system.

Furthermore, Case 1 may use the direct positioning scheme (i.e. direct AI/ML positioning) or the assisted positioning scheme (i.e. AI/ML-assisted positioning), while each of Case 2a and Case 3a may use the assisted positioning scheme. Each of Case 2b and Case 3b may use the direct positioning scheme.

The first communication node may determine an intelligent positioning model according to one of the cases shown in FIG. 11 and FIG. 12 based on at least one of the capability information report or additional information received from the second communication node.

For example, if the capability information report received at the first communication node includes an inference functionality, the first communication node may determine an intelligent positioning model based on either Case 1 or Case 2a, as shown in FIG. 11. If the capability information report received at the first communication node includes a measurement functionality, the first communication node may determine an intelligent positioning model based on Case 2b, as shown in FIG. 11. If the capability information report received at the first communication node does not include both inference and measurement functionalities, the first communication node may determine an intelligent positioning model based on either Case 3a or Case 3b, as shown in FIG. 12.

In addition, the first communication node may assign a predetermined intelligent positioning model to at least one zone corresponding to the localization result information of the additional information received from the second communication node among the multiple zones divided for the cell coverage.

According to an exemplary embodiment, each of the multiple zones for the cell coverage of the first communication node may be assigned an intelligent positioning model corresponding to each zone ID. The first communication node may determine an intelligent positioning model to be assigned to at least one zone among the multiple zones based on the additional information received from the second communication node.

Referring again to FIG. 4, after the intelligent positioning model is determined by the first communication node, the first communication node may receive a dataset from the second communication node. The first communication node may train the intelligent positioning model using the received dataset (S430).

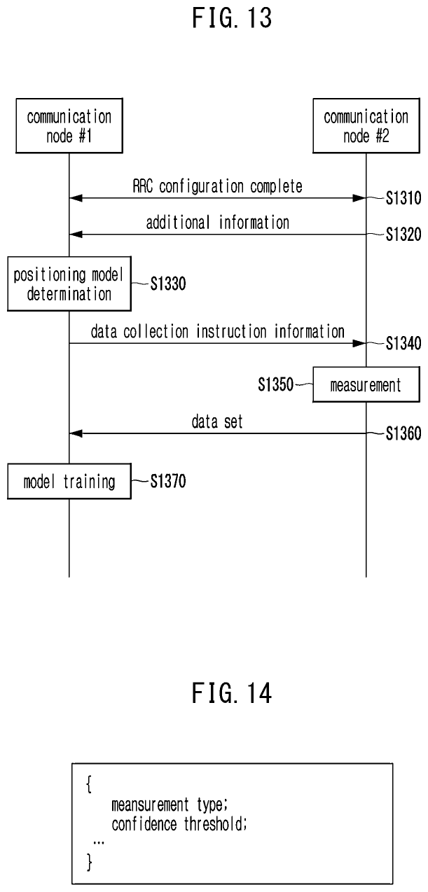

FIG. 13 is a sequence chart illustrating exemplary embodiments of a method for training an intelligent positioning model.

Referring to FIG. 13, the first communication node may perform RRC configuration for at least one positioning functionality with the second communication node (S1310). For example, the first communication node may request capability information from the second communication node, and the second communication node may transmit a capability information report to the first communication node in response to the capability information request. Based on the capability information report received from the second communication node, the first communication node may transmit RRC configuration information for at least one positioning functionality to the second communication node, and the second communication node may configure at least one positioning functionality based on the RRC configuration information received from the first communication node. The second communication node may transmit an RRC configuration completion report to the first communication node based on a configuration result, thereby completing the RRC configuration for at least one positioning functionality between the first and second communication nodes.

After the RRC configuration is complete, the second communication node may transmit additional information to the first communication node (S1320). The first communication node may determine an intelligent positioning model for the second communication node based on the additional information received from the second communication node (S1330).

The first communication node may transmit data collection instruction information to the second communication node to train the determined intelligent positioning model (S1340). Based on the data collection instruction information received from the first communication node, the second communication node may collect one or more data units through measurement (S1350).

As described above, the first and second communication nodes may share the at least one positioning functionality configured by the RRC configuration. Thus, the data collection instruction information transmitted from the first communication node to the second communication node may be an indication to collect data units corresponding to the at least one configured positioning functionality. Based on the received data collection instruction information, the second communication node may collect one or more data units corresponding to the at least one positioning functionality.

Additionally, collection of data units may be performed by the first communication node. For instance, if the intelligent positioning model determined by the first communication node is one of Case 1, Case 2a, or Case 2b in FIG. 11, collection of data units may be performed by the second communication node. However, if the intelligent positioning model determined by the first communication node is one of Case 3a or Case 3b shown in FIG. 12, collection of data units may be performed by the first communication node. In this case, the first communication node may collect data units using SRSs transmitted from the second communication node.

The second communication node may transmit a dataset including the collected data units to the first communication node (S1360). According to an exemplary embodiment, the second communication node may transmit the dataset to the first communication node along with an optimal (e.g. actual) position of the second communication node as label data. The first communication node may train the intelligent positioning model using the dataset received from the second communication node as training data (S1370).

FIG. 14 is a conceptual diagram illustrating an exemplary embodiment of data collection instruction information transmitted by a base station.

Referring to FIG. 14, the data collection instruction information may include a data type (measurement type) that the second communication node needs to collect through measurement, such as at least one type from CIR, PDP, DP, RSRP, time, or angle, and a confidence threshold for the reliability of data collection.

The second communication node may collect one or more data units through surrounding measurements based on the received data collection instruction information. The second communication node may decide to transmit a dataset including the collected data unit(s) based on localization result information outputted by performing periodic localization through the intelligent model.

For example, the second communication node may perform localization through the intelligent model to output localization result information that includes multiple probability values each of which indicates a likelihood of the second communication node being located in each of multiple zones into which the cell coverage of the first communication node is divided. The second communication node may select a probability value for a zone in which the second communication node is estimated to be located. According to an exemplary embodiment, the second communication node may select a probability value with the maximum value among the multiple probability values.

The second communication node may compare the selected probability value with the confidence threshold included in the data collection instruction information. If the selected probability value is equal to or greater than the confidence threshold, the second communication node may transmit a dataset including the collected data unit(s) to the first communication node. In this case, the second communication node may transmit a zone ID of a zone corresponding to the selected probability value along with the dataset to the first communication node. On the other hand, if the selected probability value is below the confidence threshold, the second communication node may not transmit the dataset including the collected data unit(s) to the first communication node.

Referring again to FIG. 4, after training of the intelligent positioning model is completed at the first communication node, the first communication node may transmit the trained intelligent positioning model to the second communication node to share the model.

The second communication node may use the intelligent positioning model to infer, for example, estimate the position of the second communication node. The second communication node may transmit an inference result, such as the estimated position, to the first communication node. The first communication node may determine the position of the second communication node based on the estimated location received from the second communication node (S440).

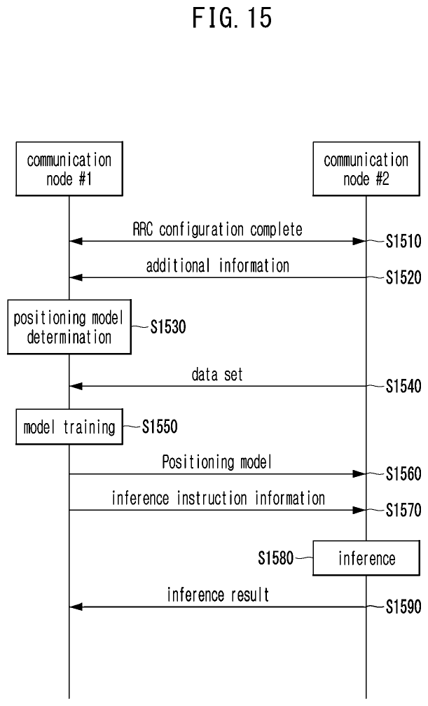

FIG. 15 is a sequence chart illustrating an exemplary embodiment of a method for determining a terminal position using an intelligent positioning model.

Referring to FIG. 15, the first communication node may perform RRC configuration for at least one positioning functionality with the second communication node (S1510). For example, the first communication node may request capability information from the second communication node, and the second communication node may transmit a capability information report to the first communication node in response to the capability information request. The first communication node may transmit RRC configuration information for at least one positioning functionality to the second communication node based on the capability information report received from the second communication node, and the second communication node may configure at least one positioning functionality based on the RRC configuration information received from the first communication node. The second communication node may transmit an RRC configuration completion report to the first communication node based on a configuration result, thereby completing the RRC configuration for at least one positioning functionality between the first and second communication nodes.

After the RRC configuration is complete, the second communication node may transmit additional information to the first communication node (S1520). The first communication node may determine an intelligent positioning model for the second communication node based on the additional information received from the second communication node (S1530).

Once the intelligent positioning model is determined, the first communication node may transmit data collection instruction information to the second communication node, and the second communication node may collect one or more data units based on the data collection instruction information received from the first communication node.

The second communication node may transmit a dataset including the collected data unit(s) to the first communication node (S1540). The first communication node may train the intelligent positioning model using the dataset received from the second communication node as training data (S1550).

Once the training of the intelligent positioning model is completed, the first communication node may transmit the trained intelligent positioning model to the second communication node (S1560). Along with the trained intelligent positioning model, the first communication node may transmit one or more parameters, such as one or more parameter values of the trained intelligent positioning model, to the second communication node. The second communication node may install the trained intelligent positioning model received from the first communication node, enabling sharing of the trained intelligent positioning model between the first and second communication nodes.

The first communication node may transmit inference instruction information to the second communication node (S1590). The inference instruction information may be an indication that instructs the intelligent positioning model to perform an inference operation, such as estimating a position of the second communication node. The inference instruction information may be transmitted to the second communication node as being included in included in a PRS.

The second communication node may estimate its position using the intelligent positioning model based on the inference instruction information received from the first communication node. The second communication node may transmit an inference result, including the estimated position, to the first communication node. The first communication node may determine the position of the second communication node based on the inference result received from the second communication node.

Referring again to FIG. 4, once the position of the second communication node is determined, the first communication node may monitor the localization result information received from the second communication node. Based on a monitoring result, the first communication node may determine if the previously determined intelligent positioning model needs to be switched (or changed) (S450).

The first communication node may periodically transmit PRS or SSB to the second communication node according to a preset periodicity. The second communication node may perform periodic localization of the second communication node using the intelligent model based on the received PRS or SSB. The second communication node may transmit localization result information to the first communication node.

As described above, the localization result information may include multiple probability values each of which indicates a likelihood of the second communication node being located within each of the multiple zones within the cell coverage of the first communication node. Based on the multiple probability values in the received localization result information, the first communication node may obtain a probability value (e.g. first probability value) of a zone in which the second communication node is located. The first communication node may compare the first probability value with a preset reference value and determine whether to switch the intelligent positioning model based on a comparison result.

For example, if the first probability value is below the reference value, the first communication node may determine that the previously determined intelligent positioning model needs to be switched. The first communication node may check for presence of a probability value (e.g. second probability value) among the multiple probability values in the localization result information, which is greater than the first probability value. If the second probability value exists, the first communication node may switch the previously determined intelligent positioning model to an intelligent model assigned to a zone corresponding to the second probability value among the multiple zones (S460). The first communication node may then receive a dataset from the second communication node and retrain the switched intelligent positioning model using the data set (S430).

Additionally, if the first probability value is equal to or greater than the reference value, the first communication node may maintain the existing intelligent positioning model.

As described above, the method for intelligent positioning in the present disclosure allows the first communication node to configure a positioning functionality for the second communication node, determine an intelligent positioning model, and train the intelligent positioning model by receiving a dataset corresponding to the positioning functionality from the second communication node. Thus, the present disclosure enhances the training performance of the intelligent positioning model and improves the positioning accuracy for the second communication node using the intelligent positioning model.

Furthermore, the present disclosure enhances an operational reliability of the intelligent positioning model by enabling the first communication node to determine a need for changing the intelligent model through performance monitoring of the intelligent positioning model based on localization results for the respective zones of the cell coverage received from the second communication node.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
determining an intelligent positioning model including at least one positioning functionality for positioning of a second communication node based on a capability information report received from the second communication node;
training the intelligent positioning model using a data set received from the second communication node;
transmitting the trained intelligent positioning model to the second communication node; and
receiving, from the second communication node, an inference result through the intelligent positioning model, and determining a position of the second communication node.

2. The method according to claim 1, wherein the determining of the intelligent positioning model comprises:
transmitting a capability information request to the second communication node;
in response to the capability information request, receiving, from the second communication node, a capability information report including a plurality of positioning functionalities supportable by the second communication node;
transmitting, to the second communication node, Radio Resource Control (RRC) configuration information for configuring at least one positioning functionality among the plurality of positioning functionalities, based on the capability information report;
receiving, from the second communication node, an RRC configuration completion report for the RRC configuration information; and
determining the intelligent positioning model including the configured at least one positioning functionality.

3. The method according to claim 1, wherein the determining of the intelligent positioning model comprises:
dividing a cell coverage of the first communication node into a plurality of zones;
transmitting, to the second communication node, division information for the plurality of zones;
receiving, from the second communication node, additional information including localization result information on a result of localization performed based on the division information; and
determining the intelligent positioning model based on at least one of the at least one positioning functionality and the additional information.

4. The method according to claim 3, wherein the division information includes a cell identifier (ID) for the first communication node and a zone ID for each of the plurality of zones, the localization result information includes a plurality of probability values each of which is a probability that the second communication node is located in each of the plurality of zones, and the additional information includes zone ID(s) of at least one zone corresponding to at least one probability value including a maximum probability value among the plurality of probability values of the localization result information among the plurality of zones.

5. The method according to claim 1, wherein the training of the intelligent positioning model comprises:
transmitting data collection instruction information to the second communication node; and
receiving, from the second communication node, the data set including at least one data unit collected based on the data collection instruction information.

6. The method according to claim 1, wherein the determining of the position of the second communication node comprises:
transmitting inference instruction information to the second communication node;
receiving, from the second communication node, the inference result including an estimated position of the second communication node obtained through the intelligent positioning model; and
determining the position of the second communication node based on the estimated position.

7. The method according to claim 1, further comprising:
dividing a cell coverage of the first communication node into a plurality of zones and transmitting division information for the plurality of zones to the second communication node;
receiving, from the second communication node, localization result information on a result of localization performed based on the division information at a preset periodicity; and
determining whether to switch the determined intelligent positioning model based on the localization result information.

8. The method according to claim 7, wherein the localization result information includes a plurality of probability values each of which is a probability that the second communication node is located in each of the plurality of zones, and the determining of whether to switch the intelligent positioning model comprises:
comparing a probability value of a zone corresponding to the position of the second communication node among the plurality of zones with a preset reference value, based on the plurality of probability values; and
in response to the probability value being less than the preset reference value, switching the intelligent positioning model.

9. A method of a second communication node, comprising:
in response to a capability information request received from a first communication node, transmitting, to the first communication node, a capability information report including a plurality of positioning functionalities supportable by the second communication node;
configuring at least one positioning functionality among the plurality of positioning functionalities based on Radio Resource Control (RRC) configuration information received from the first communication node;
in response to data collection instruction information received from the first communication node, collecting one or more data units corresponding to the at least one positioning functionality, and transmitting a data set including the collected data units to the first communication node;
receiving, from the first communication node, an intelligent positioning model trained by the data set; and
in response to inference instruction information received from the first communication node, estimating a position of the second communication node using the intelligent positioning model, and transmitting an inference result including the estimated position to the first communication node.

10. The method according to claim 9, further comprising:
receiving, from the first communication node, division information for a plurality of zones into which a cell coverage of the first communication node is divided;
determining localization result information including a plurality of probability values each of which is a probability that the second communication node is located in each of the plurality of zones by performing localization of the second communication node based on the division information; and
transmitting, to the first communication node, additional information including the localization result information.

11. The method according to claim 10, wherein the additional information includes zone identifier(s) (ID(s)) for at least one zone corresponding to at least one probability value including a maximum probability value among the plurality of probability values of the localization result information among the plurality of zones.

12. The method according to claim 10, wherein the data collection instruction information includes a threshold value, and the transmitting of the data set comprises:
comparing a probability value for a zone in which the second communication node is located among the plurality of probability values with the threshold value; and
in response to the probability value being equal to or greater than the threshold value, transmitting the data set to the first communication node,
wherein the data set is not transmitted when the probability value is less than the threshold value.

13. A first communication node comprising at least one processor, wherein the at least one processor causes the first communication node to perform:
determining an intelligent positioning model including at least one positioning functionality for positioning of a second communication node based on a capability information report received from the second communication node;
training the intelligent positioning model using a data set received from the second communication node;
transmitting the trained intelligent positioning model to the second communication node; and
receiving, from the second communication node, an inference result through the intelligent positioning model, and determining a position of the second communication node.

14. The first communication node according to claim 13, wherein in the determining of the intelligent positioning model, the at least one processor causes the first communication node to perform:
transmitting a capability information request to the second communication node;
in response to the capability information request, receiving, from the second communication node, a capability information report including a plurality of positioning functionalities supportable by the second communication node;
transmitting, to the second communication node, Radio Resource Control (RRC) configuration information for configuring at least one positioning functionality among the plurality of positioning functionalities, based on the capability information report;
receiving, from the second communication node, an RRC configuration completion report for the RRC configuration information; and
determining the intelligent positioning model including the configured at least one positioning functionality.

15. The first communication node according to claim 13, wherein in the determining of the intelligent positioning model, the at least one processor causes the first communication node to perform:
dividing a cell coverage of the first communication node into a plurality of zones;
transmitting, to the second communication node, division information for the plurality of zones;
receiving, from the second communication node, additional information including localization result information on a result of localization performed based on the division information; and
determining the intelligent positioning model based on at least one of the at least one positioning functionality and the additional information.

16. The first communication node according to claim 15, wherein the division information includes a cell identifier (ID) for the first communication node and a zone ID for each of the plurality of zones, the localization result information includes a plurality of probability values each of which is a probability that the second communication node is located in each of the plurality of zones, and the additional information includes zone ID(s) of at least one zone corresponding to at least one probability value including a maximum probability value among the plurality of probability values of the localization result information among the plurality of zones.

17. The first communication node according to claim 13, wherein in the training of the intelligent positioning model, the at least one processor causes the first communication node to perform:
transmitting data collection instruction information to the second communication node; and
receiving, from the second communication node, the data set including at least one data unit collected based on the data collection instruction information.

18. The first communication node according to claim 13, wherein in the determining of the position of the second communication node, the at least one processor causes the first communication node to perform:
transmitting inference instruction information to the second communication node;
receiving, from the second communication node, the inference result including an estimated position of the second communication node obtained through the intelligent positioning model; and
determining the position of the second communication node based on the estimated position.

19. The first communication node according to claim 13, wherein the at least one processor further causes the first communication node to perform:
dividing a cell coverage of the first communication node into a plurality of zones and transmitting division information for the plurality of zones to the second communication node;
receiving, from the second communication node, localization result information on a result of localization performed based on the division information at a preset periodicity; and
determining whether to switch the determined intelligent positioning model based on the localization result information.

20. The first communication node according to claim 13, wherein the localization result information includes a plurality of probability values each of which is a probability that the second communication node is located in each of the plurality of zones, and in the determining of whether to switch the intelligent positioning model, the at least one processor causes the first communication node to perform:
comparing a probability value of a zone corresponding to the position of the second communication node among the plurality of zones with a preset reference value, based on the plurality of probability values; and
in response to the probability value being less than the preset reference value, switching the intelligent positioning model.
